(19) United States
(12) Patent Application Publication
(10) Pub. No.: US 2023/0192312 A1
(43) Pub. Date: Jun. 22, 2023

(54) ELECTRONIC DEVICE, AND METHOD, FOR GUIDING THE PILOT IN PILOTING AN AIRCRAFT DURING LANDING IN THE PRESENCE OF A CROSSWIND

(71) Applicant: THALES, COURBEVOIE (FR)

(72) Inventors: Frédéric BERGER, TOULOUSE (FR); Thierry GANILLE, MERIGNAC (FR); Didier POISSON, MERIGNAC (FR); Pierre-Yves DUMAS, VALENCE (FR)

(21) Appl. No.: 17/924,969

(22) PCT Filed: May 12, 2021
(86) PCT No.: PCT/EP2021/062593

§ 371 Date: Nov. 11, 2022

(30) Foreign Application Priority Data
May 13, 2020 (FR) 20 04702

(51) Int. Cl. B64D 43/02; B64D 45/08; G01C 23/00

(52) U.S. Cl. CPC B64D 43/02; B64D 45/08; G01C 23/005

(57) ABSTRACT

Disclosed is a method of guiding the pilot of an aircraft for the alignment maneuver, including: determining at a first instant an occurrence close to the alignment maneuver and triggering the display of a first symbol on the screen; updating the position of the first symbol on the horizon according to the updated value of the aircraft heading; when the alignment maneuver is to begin, moving a second symbol on the screen from the position of the first symbol, the direction of the displacement with respect to the horizon being determined depending on the direction of the crosswind with respect to the runway and the value of the displacement being determined depending on the difference between the current dynamic sideslip of the aircraft and a current dynamic sideslip setpoint value calculated for the aircraft.

### CROSS-REFERENCE TO RELATED APPLICATIONS

This application is the U.S. national phase of International Application No. PCT/EP2021/062593 filed May 12, 2021 which designated the U.S. and claims priority to FR Patent Application No. 20 04702 filed May 13, 2020, the entire contents of each of which are hereby incorporated by reference.

### BACKGROUND OF THE INVENTION

### Field of the Invention

The present invention relates to the field of piloting an aircraft for the maneuver of aligning the aircraft heading with the axis of the runway during the final landing phase. The difficulty of performing the maneuver increases with the intensity of the crosswind, which can then lead to exiting the runway or damage to the landing gear.

### Description of the Related Art

During the landing phase of an aircraft in the presence of crosswind, the longitudinal axis of the aircraft (herein also called heading) is oriented toward the origin of the wind while the trajectory of the aircraft (herein also called route) is the trajectory of the runway centerline. The angle thus formed between the heading and the route, called drift, is proportional to the intensity of the crosswind. A few seconds before landing the aircraft, the pilot has to partially align the aircraft heading so as to reduce the forces on the landing gear during the contact with the ground and so as to prevent the aircraft from subsequently having a tendency to deviate from the runway centerline. The pilot has to do such maneuver while performing a flare of the vertical trajectory (in order to decrease the vertical speed at impact) and while maintaining the trajectory of the aircraft along the runway centerline.

Such complex maneuver has to be performed within a short time and ideally in a single movement on the control units. In this way, little time is left for the pilot to make any corrections, if appropriate, in the event of poor maneuvering or of a gust of wind.

Moreover, during such phase, the pilot should have the eyes directed toward the outside of the cockpit in order to visually acquire the runway markings which would enable the pilot to touch down safely. The use of display for piloting information in the field of view of the pilot is then a considerable help. To overcome the disadvantage of fixed displays along the axis of the aircraft, such as “Head Up Display (HUD)”, it is now possible to use displays worn by the head of the pilot “Head Worn Display (HWD)”. In fact, in the event of a strong crosswind, the drift can be greater than the field of view of such display, so the pilot may not see the runway through the display. The head-worn display then allows the pilot to turn the head toward the runway while keeping the piloting information. However, in the presence of crosswind with such type of head-worn display, the pilot can then minimize their perception thereof of the difference between the heading and the runway centerline and no longer be aware of the need for the alignment maneuver. Indeed, the pilot would naturally turn their head toward where they want to go, i.e. the runway, and not along the axis of the aircraft.

Currently, there is no display of a dedicated indicator in the cockpit for assisting the pilot in such alignment maneuver. In the event of a crosswind, a poor maneuver can lead to exiting the runway or to damage to the landing gear. A correct maneuver is based either on the know-how of the pilot or on an automatic system which performs the maneuver instead of the pilot.

Most head-up displays can now provide heading, route and runway centerline information.

U.S. Pat. No. 10,460,613 e.g. proposes a display of three symbols: the first is an indication of alignment with the runway centerline, the second is an indication of the aircraft heading and the third is an indication of the route of the aircraft with an indication of the trend of the evolution of same route. Such symbols can also be used during the intercept phase of the runway centerline.

However, it remains necessary to assist the pilot in performing the maneuver. Moreover, such solutions do not solve the minimization of the pilot's perception of the difference between the heading and the runway centerline with a head-worn display and [the problem of] no longer being aware of the need for the alignment maneuver.

### SUMMARY OF THE INVENTION

To this end, according to a first aspect, the invention proposes an electronic device for guiding the pilot in the piloting of an aircraft for performing the alignment maneuver of the longitudinal axis of the aircraft with the runway centerline during the landing of said aircraft in the presence of a crosswind,

said device being suitable for determining at a first instant, an occurrence close to the alignment maneuver and to trigger, upon said determination of the near occurrence, a first display command controlling the appearance, on a display medium intended for the pilot and displaying the horizon graduated according to a heading scale, of at least one first symbol at a specified position on the display medium with respect to the graduation of the horizon line;

said device being suitable for updating the current position of the first symbol on the horizon depending on the updated value of the aircraft heading;

said device being suitable for determining, at a second instant strictly following said first instant, that the alignment maneuver should now begin and then for triggering a second display command controlling a movement of a second symbol on the display medium, from the position of the first symbol, the direction of said displacement with respect to the horizon being determined depending on the direction of the crosswind with respect to the runway, and the value of the displacement being determined depending on the difference between the current dynamic sideslip of the aircraft and a current dynamic sideslip setpoint value calculated for the aircraft, said current dynamic sideslip corresponding to the angle between the current air speed of the aircraft and the current heading of said aircraft.

The invention thus makes it possible to indicate the appropriate instant and the way of performing the alignment maneuver.

In some embodiments, a method of controlling according to the invention further includes one or more of the following characteristics:
the first symbol is an aircraft heading reminder symbol and the device is suitable for determining the position of the heading reminder symbol with respect to the runway centerline mark along said horizon depending on the angle between the aircraft heading and the runway centerline; or
The first symbol is a dynamic sideslip reminder symbol, and the device is suitable for determining the position of the dynamic sideslip reminder symbol with respect to the ground speed mark of the aircraft along said horizon depending on said dynamic sideslip, a zero dynamic sideslip giving rise to the same position, on the horizon, of said first symbol and of the ground speed mark;
the electronic guiding device is suitable for controlling the display on the display medium of the first symbol at a given distance with respect to said mark; the guiding device being suitable for determining said distance depending on the multiplication of a scale factor strictly less than 1 and of an angle difference with respect to the heading scale of said horizon on the display medium, said angle difference being the angle between the aircraft heading and the runway centerline when the first symbol is an aircraft heading reminder symbol, being the dynamic sideslip angle, respectively, when the first symbol is a dynamic sideslip reminder symbol;
the guiding device is suitable for triggering, at said second instant, an appearance modification command controlling an appearance modification of the first symbol displayed on said display medium.

According to a second aspect, the present invention proposes a method of guiding the pilot in the piloting of an aircraft for performing the maneuver of alignment of the longitudinal axis of the aircraft with the runway centerline during the landing of said aircraft in the presence of a crosswind, using an electronic guiding device implementing the following steps:
determining at a first instant, an occurrence close to the alignment maneuver and initiating, upon the determination of the near occurrence, of a first display command to controlling the appearance on a display medium intended for the pilot and displaying the horizon graduated according to a heading scale, of at least one first symbol at a specified position on the display medium with respect to the horizon line;
updating the current position of the first symbol on the horizon according to the updated value of the aircraft heading;
determining, at a second instant strictly following said first instant, that the alignment maneuver should now begin and then triggering a second display command controlling a movement of a second symbol on the display medium, from the position of the first symbol, the direction of said displacement with respect to the horizon being determined depending on the direction of the crosswind with respect to the runway, and the value of the displacement being determined depending on the difference between the current dynamic sideslip of the aircraft and a current dynamic sideslip setpoint value calculated for the aircraft, said current dynamic sideslip corresponding to the angle between the current air speed of the aircraft and the current heading of said aircraft.

In some embodiments, a method of guiding according to the invention further includes one or more of the following features:
the first symbol is an aircraft heading reminder symbol and the position of the heading reminder symbol is determined with respect to the runway centerline mark along said horizon depending on the angle between the aircraft heading and the runway centerline; or
the first symbol is a dynamic sideslip reminder symbol, and the device is suitable for determining the position of the dynamic sideslip reminder symbol with respect to the ground speed mark of the aircraft along said horizon depending on said dynamic sideslip, a zero dynamic sideslip giving rise to the same position, on the horizon, of said first symbol and of the ground speed mark;
the guiding method comprises a step of controlling, by means of the guiding device, the display on the display medium of the first symbol at a given distance with respect to said mark; according to which method, said distance is determined by the guiding device depending on the multiplication of a scale factor strictly less than 1 and of an angle difference with respect to the heading scale of said horizon on the display medium, said angle difference being the angle between the aircraft heading and the runway centerline when the first symbol is an aircraft heading reminder symbol, being the dynamic sideslip angle, respectively, when the first symbol is a dynamic sideslip reminder symbol;
the guiding method comprises a step of triggering, by means of the guiding device, at said second instant, an appearance modification command controlling an appearance modification of the first symbol displayed on said display medium;
the steps triggered at the second instant prompt the pilot to perform the alignment maneuver so that the first symbol stays as close as possible to the second symbol.

According to a third aspect, the invention further relates to a computer program including software instructions which, when executed by a computer, implement a method as defined hereinabove.

### BRIEF DESCRIPTION OF THE DRAWINGS

The features and advantages of the invention will appear upon reading the following description, given only as an example, and making reference to the enclosed drawings, wherein:

FIG. 1 shows a view of an aircraft approaching, in the presence of crosswind;

FIG. 2 illustrates the aircraft sideslip maneuver shown in FIG. 1 during the final alignment maneuver;

FIG. 3 represents a content usually displayed on a display medium of a display system for the pilot of an aircraft;

FIG. 4 represents a partial view displayed on a screen of a display system for the pilot of an aircraft in an embodiment of the invention;

FIG. 5 represents a partial view displayed on a screen of a display system for the pilot of an aircraft in an embodiment of the invention;

FIG. 6 represents a partial view displayed on a screen of a display system for the pilot of an aircraft in an embodiment of the invention;

FIG. 7 schematically shows a piloting assistance system according to an embodiment of the invention;

FIG. 8 is an organization chart of the steps implemented in an embodiment of the invention.

### DESCRIPTION OF THE PREFERRED EMBODIMENTS

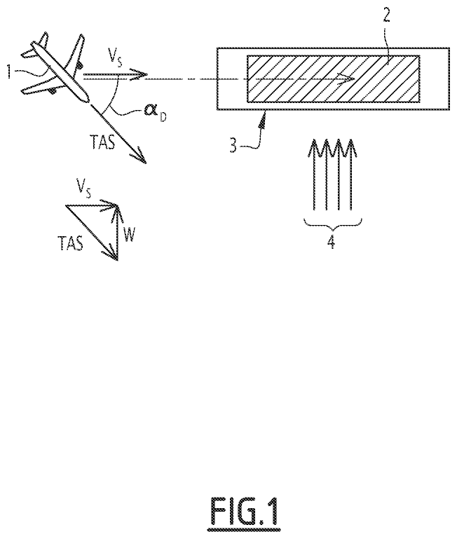

An aircraft 1, herein an aircraft 1 implementing the invention 1 is shown in FIG. 1 approaching a runway 3 which includes the landing area 2 of the aircraft 1.

During a crosswind approach (i.e. a wind [blowing] in a direction not parallel to the runway), represented by the arrows 4 in FIG. 1, the aircraft 1, behaving like a wind vane, would orient the longitudinal axis thereof toward the direction from which the wind comes and fly with a drift angle α_{D}.

Compared to air, the aircraft 1 flies with a speed vector called TAS (True Air Speed). The air is moving according to the speed vector, called wind speed W. Finally, the aircraft 1 moves with respect to the ground with a speed vector, known as Ground speed Vs.

When the crosswind is strong, the pilot of the aircraft 1 has to reduce the drift angle so as to reduce the lateral force on the landing gear and to obtain a taxiing trajectory along the runway centerline so as to avoid exiting the runway. Indeed, once in contact with the ground, the tires of the landing gear will create significant forces that the landing gear will have to withstand and which will greatly modify the trajectory of the aircraft.

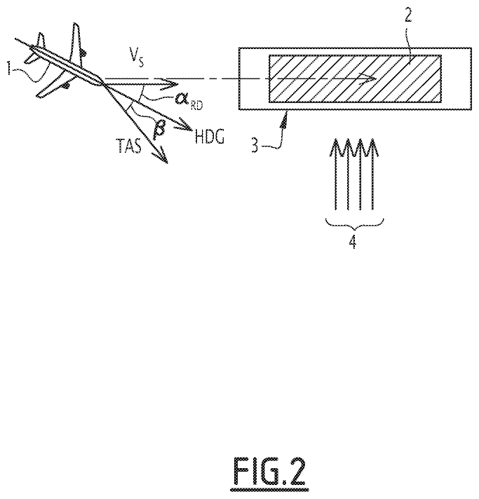

Before landing, the pilot will have to reduce the gap between the aircraft heading and the orientation of the runway, i.e. perform an alignment maneuver between the two axes, by creating the aerodynamic sideslip—FIG. 2 shows the aerodynamic sideslip angle β and the aircraft heading, called HDG, after the sideslip-, but keep a part (α_{RD}) of the initial angle α_{D} to compensate, during taxiing, for the aerodynamic forces that the wind will generate on the aircraft. At the same time, the pilot has to maintain the ground speed vector along the runway centerline. Since the aerodynamic sideslip generates a lateral force, the pilot has to compensate for the force by skewing the aircraft laterally.

The aerodynamic sideslip is performed by the pilot via pedals moving a movable surface on the vertical empennage and giving rise to aerodynamic sideslip.

During such same final phase before landing, the pilot has to further perform a flare. Such maneuver consists in raising the nose of the aircraft in order to decrease the vertical speed of the aircraft on impact. There are currently aids for performing such maneuver, called “Flare Cue” or “Flare Prompt”.

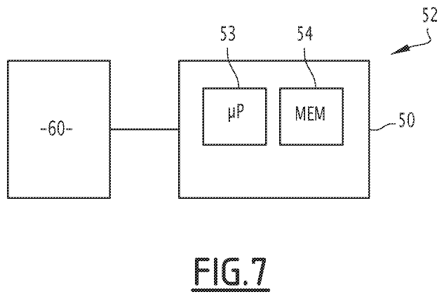

In one embodiment, with reference to FIG. 7, the aircraft 1 includes an on-board piloting assistance system 52, including a display system 60 and a guiding device 50.

The display system 60 includes a display support, typically a screen, and is suitable for displaying on the display support, fixed with respect to the aircraft or mobile by following the head movements of the pilot, in a known manner, information intended for the pilot during such phase.

The display system 60 is e.g. in the present case, a HUD (head-up) or HWD (head-worn) display system

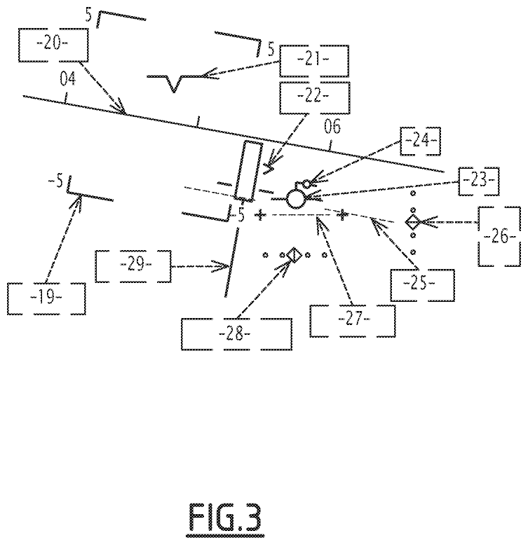

In particular, the display system 60 is suitable for displaying on the display medium intended for the pilot, as is known and as represented in FIG. 3:
the aircraft scale model 21, which is the trace of the longitudinal axis of the aircraft 1, indicating the heading of the aircraft 1; the position of the scale model with respect to the horizon gives the information on lateral inclination (“Roll Angle”) and on the longitudinal attitude or pitch (“Pitch Angle”);
the horizon 20, a line representing the local horizontal and graduated by a heading scale (the graduation 04 indicating a heading of 40 degrees with respect to the North, the graduation 06 indicating a heading of 60 degrees with respect to the North, etc.);
the pitch scale 19;
the ground speed vector 23 (FPV “Flight Path Vector” which indicates the direction wherein the aircraft is heading, i.e. the vector Vₛ shown in FIG. 1 with respect to the horizon 20;
the potential slope (or energy chevron) (22);
the Flight Path Director 24 (FPD), which tells the pilot what actions to take with the stick thereof along the longitudinal and lateral axes;
a flare assistance 27 (“Flare Cue” or “Flare Prompt”);
an indication 25 of the reference of the approach slope (FPARC “Flight Path Angle Reference Cue”);
the orientation 29 of the runway centerline with respect to the horizon 20;
the lateral 28 and vertical 26 differences, on a lateral and vertical difference scale, respectively, from the approach path;

This information is provided by a number of equipment items on board the aircraft, based on measurements and/or calculations.

According to the invention, the piloting assistance system 52 is suitable for displaying on the display medium of the display system 60, a set of two additional marks in addition to said information, so as to guide the pilot in the alignment maneuver thereof during the landing phase.

In the present case, the set of two marks includes a parameter reminder mark and an alignment assistance mark.

The commands triggering the display of such marks and defining the positions thereof are provided by the guiding device 50 shown in FIG. 7 in one embodiment of the invention

In one embodiment, the guiding system 50 includes a processor 53 and a memory 54.

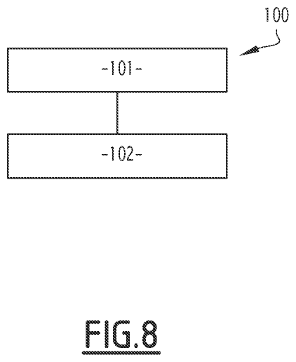

The memory 54 comprises software instructions which, when executed on the processor 53, automatically implement the steps belonging to the processing device 50 described with reference to FIG. 8.

FIG. 8 is an organization chart 100 of the main steps implemented in an embodiment of the invention.

In a first step 101, a few seconds (e.g. between 2 and 10 seconds) before the estimated start of the alignment maneuver, the guiding device 50 commands the display of the two marks at the same point on the display medium (the marks can be completely superimposed or slightly offset from each other).

The position of the point recalls the value of the parameter considered and depends on the angular difference between the aircraft heading (i.e. the longitudinal axis thereof) and the runway centerline.

Such display warns the pilot, in advance of the phase, of the imminence of the alignment maneuver and thus tells the pilot to prepare to perform said maneuver.

In a second step 102 triggered by the guiding device 50 at the instant when the alignment maneuver by the pilot is to begin, the guiding device 50 controls e.g. a change of appearance in the display of one and/or the other of the two marks (e.g. the display becomes flashing or stops flashing and/or changes from fine or dotted lines to bold or solid lines, etc.), the guiding device 50 then controls a displacement on the display medium of the alignment assistance mark depending on the difference between the actual dynamic sideslip of the aircraft and a calculated dynamic sideslip setpoint for the aircraft.

The second step thus makes it possible to clearly alert when the maneuver should begin and [when] to display the direction and the dynamics (the speed) with which the maneuver has to be performed.

The movement of the alignment assistance mark on the display medium then controlled by the guiding device 50 indicates to the pilot the dynamics to be followed by the parameter reminder mark in order to perform the maneuver correctly, the position of the parameter reminder mark being always dependent on the angular difference between the aircraft heading (i.e. the longitudinal axis thereof) and the runway centerline.

Indeed, the goal for the pilot is, in the second step, to implement the alignment by performing an aerodynamic sideslip via the pedals, such that the parameter reminder mark (which moves on the display support according to the maneuver) stays superimposed on the alignment assistance mark (the latter moving according to the difference, updated in real time, between the current sideslip of the aircraft and the sideslip setpoint also updated in real time).

In a first embodiment, the parameter reminder mark is an aircraft heading reminder mark.

In a second embodiment, the parameter reminder mark is an aircraft sideslip reminder mark.

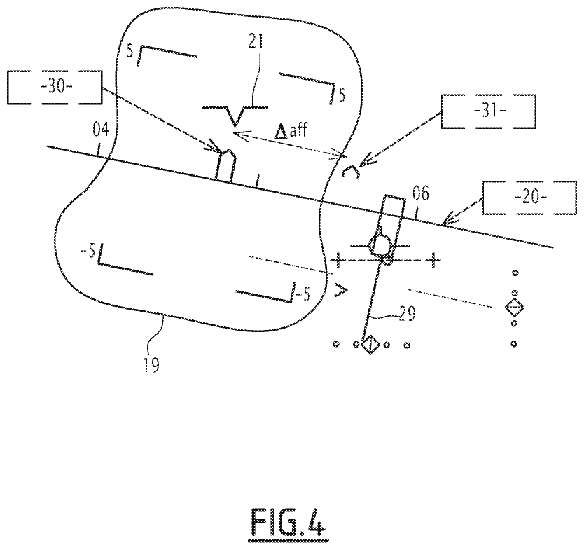

Such embodiments, and some of the possible variants thereof, are now described in greater detail with reference to FIGS. 4, 5, 6, which represent the display medium of the display system 60 during the step 102, i.e. during the alignment maneuver. However, to prevent cluttering the figures, not all the information actually present on the display medium as listed above with reference to FIG. 3, is shown.

Moreover, it should be noted that the direction of the wind, in the situations illustrated in the FIGS. 4, 5, 6 is opposite to the direction represented in FIGS. 1 and 2.

FIG. 4 corresponds to an embodiment where the parameter reminder reference mark is an aircraft heading reminder mark 30.

The heading reminder mark 30 (“heading carrot”) of the aircraft 1 is displayed herein above the horizon line 20 (same can be displayed, depending on the embodiments, above or below the horizon line, whether or not attached to the latter) The mark indicates the current value of the aircraft heading and is positioned, along the horizon line, relative to the orientation of the runway centerline 29, i.e. depending on the angular difference between the aircraft heading 1 and the runway centerline 29 (the runway symbol (the rectangle above the runway centerline) is placed where the runway is located; thus, if the aircraft is heading toward the runway, but from a direction different from the runway centerline, then the symbol 29 is not aligned with the orientation of the runway centerline on the heading scale; the heading reminder symbol is placed relative to the orientation of the runway on the horizon heading scale).

In the embodiment shown in FIG. 4, the heading reminder mark 30, during steps 101, 102, is at the same graduation of the heading scale indicated by the horizon 20 as the aircraft scale model 21 (scale factor k equal to 1).

Optionally, during the steps 101, 102, the position of the heading reminder mark can be not according to the heading scale 20, so as to remain visible on the display even in the event of a strong crosswind while the head of the pilot is facing the runway.

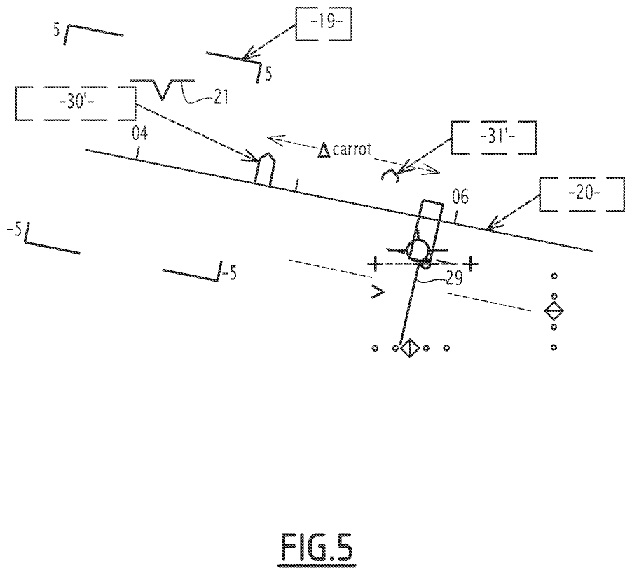

A scale factor, with a calculated value between [0, 1] then applies, upon command from the guiding device 50, on the difference between the aircraft heading and the runway orientation and in such a case, as shown in FIG. 5, the heading reminder mark 30′ is placed with respect to the orientation of the runway centerline 29 on the horizon at a distance Δ_carrot, equal to the scale factor k_{aff} multiplied by the angular difference between the heading of the aircraft 1 and the runway centerline 29. Thus, the heading reminder mark 30′ is no longer aligned with the aircraft model 21.

The alignment assistance mark in step 102 tells the pilot how to move the heading reminder mark to properly perform the maneuver. Such alignment assistance mark is referenced by 31 in FIG. 4, by 31′ in FIG. 5, is moved with respect to the heading reminder along the horizon to a position prescribed by the piloting command triggered by the piloting device 50 controlling said displacement on the screen of the alignment assistance mark (and in one embodiment, the command indicates not only the updated position at which the alignment assistance mark should be placed, but also the speed at which the alignment assistance mark moves from the position of the parameter reminder mark to that updated position), coming from the guiding device 50, and further applying the same scale factor k_{aff} in the case where a scale factor is used (the displacement toward the position of the alignment assistance mark is indicated in the figure by the segment Δaff).

It is the guiding device 50 which indicates in the command thereof, during the steps 101 and 102, whether a scale factor k different from 1 has be taken into account in the display of the two marks according to the invention and in such case, the guiding device 50 indicates the value of k therein.

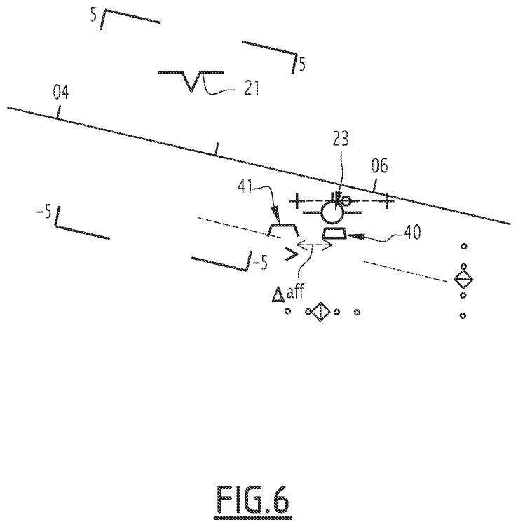

As introduced above, in a second embodiment illustrated in FIG. 6, the parameter reminder mark is a sideslip reminder mark of the aircraft corresponding to the current value of the angle β between the aircraft heading and the speed vector TAS (cf. FIG. 2).

The guiding device 50 controls, during the step 101, the display of the sideslip reminder mark 40 of the aircraft below the ground speed vector 23 (“FPV”). At such instant, the value of the sideslip is zero.

The alignment assistance mark, referenced by 41 in FIG. 6, is placed with respect to the slideslip reminder mark 40 according to a positioning piloting command (Δaff) coming from the time-dependent guiding device 50, by further applying the same scale factor k in the case where a scale factor is used.

Like in the first embodiment, the alignment assistance mark 41 thus indicates to the pilot how the pilot should move the other mark, herein the sideslip reminder mark 40 so as to correctly perform the alignment maneuver. In the example shown in FIG. 6, the alignment assistance mark 41 deviates to the left so as to indicate to the pilot that the sideslip reminder mark 40 thereof has to deviate to the left. The pilot then depresses the pedal on the side where the sideslip reminder mark is located in relation to the alignment assistance mark (herein the right pedal) so as to bring same back to the center of the latter.

It should be noted that in another embodiment, the guiding device 50 could also move the alignment assistance to the right to indicate to the pilot to press to the right, and then the sideslip would shift to the left and it is the alignment assistance which would recenter on the sideslip reminder.

The goal for the pilot in the maneuver thereof is to perform the latter in such a way as to keep the two markers superimposed on each other.

In one embodiment, the time of appearance of the marks (step 101) is determined by the guiding device 50 depending on the height of the aircraft 1 with respect to the ground, called the radio height, measured e.g. by an altimetric radio probe, of the vertical speed of the aircraft, called Speed_{vertical}, and a predefined threshold, called Height_{Appearance}, as follows:

as soon as Height_{Radio}+t·Speed_{vertica}<Height_{Appearance}, the triggering of step 101 (t is a constant with a determined value, with the value being comprised between 2 and 10 seconds).

Optionally, the vertical speed can be averaged and filtered in order to eliminate the variations due to aerodynamic turbulence and to trajectory adjustments made by the pilot.

Alternatively, the instant of appearance can be determined depending on the distance to the runway threshold, e.g. measured by a DME or GPS block, called Distance_{DME/GPS}, of the ground speed of the aircraft, called Speed_{ground}, and of a predefined threshold, called Distance_{Appearance}, as follows:

as soon as Distance_{DME/GPS}+t′·>Speed_{ground}<Distance_{Appearance}, the triggering of step 101 (t′ is a constant with determined value, the value being comprised between 2 and 10 seconds).

In the embodiment considered, the distance of the displacement of the alignment assistance mark 31, 31′, 41, with respect to the parameter (heading or sideslip) reminder mark 30, 30′, 40 on the display medium controlled during the step 102, is determined by the guiding device 50 depending on the difference between the current aerodynamic sideslip of the aircraft, β, and the current sideslip setpoint, βₛₑₜₚₒᵢₙₜ.

The displacement between the two marks is e.g. proportional to such difference. The relationship e.g. may not be proportional, but follows a rising curve, i.e. the displacement increases when the difference increases.

The difference is calculated as follows:

Δ_{aff}=k_{aff}·(β−βₛₑₜₚₒᵢₙₜ)

The current value of the aerodynamic sideslip β can be obtained by the guiding device 50 in a plurality of ways:

a measurement with a sideslip probe,

an estimate based on inertial measurements (lateral acceleration, lateral inclination and pitch, roll and yaw rate, etc.), air speed measurement (TAS), the difference in static pressure measurements and optionally the position of movable surfaces (especially rudder, etc.) which generate lateral forces,

a hybridization between the previous 2.

In the case considered, the sideslip setpoint β is obtained depending on the sum of the current sideslip (β) and the difference (angle) between the aircraft heading (“heading”) and the orientation of the runway centerline (“Course”), e.g. proportionally to said sum:

βₛₑₜₚₒᵢₙₜ=k_{align}·(β+(Heading−Course))

The align proportionality factor k_{align} allows the residual drift to be adjusted. Optionally, such setpoint can be delayed/filtered and limited in speed and amplitude so as to be representative of the actual behavior of the aircraft.

The relationship between the heading difference and the set point e.g. may not be proportional, but follows a rising curve in order to better take physical non-linearities into account.

Advantageously, at the same time, the flight director (FPD) is modified laterally so as to indicate the corrections to be made on the side handle in order to maintain the trajectory of the aircraft along the axis.

In addition to a lateral difference, the flight director sometimes presents a lateral inclination setpoint in the form of small wings (See FIG. 3). In such case, the invention makes it possible to directly indicate the correct skewing to be taken for performing the alignment maneuver.

The 2 effects on the flight director are controlled directly by the relationship between the aerodynamic sideslip and the lateral inclination necessary for maintaining a rectilinear flight.

The invention makes it possible to warn the pilot of the imminence of the maneuver by the appearance of two symbols in the same place on the display. The start time of the maneuver is identified by the change in appearance of said symbols and the setting in motion of the guiding symbol. The latter then indicates the dynamics to be followed by the other symbol so as to perform the maneuver correctly. The pilot then acts on the pedals so as to follow said movement.

On the other hand, the flight director symbol further provides an indication of the roll angle and the commands to be applied to the lateral control element (handle or handwheel) necessary for compensating for the tendency of variation of the route, as introduced by such maneuver.

The invention thus provides assistance in piloting aircraft during the landing phase. In some embodiments, the assistance is integrated into a display system for aircraft flight control stations (head-down, fixed head-up and head-worn screens) or further into a system of flight assistance/guiding (automatic pilot, flight director, AFCGS “Auto Flight Control and guiding System”).

Hereinabove, the appearance of the two marks during the step 101, in a superimposed manner, has been described; of course, in another embodiment, only the first mark is displayed during the step 101; the second mark is displayed during the step 102.

In another embodiment, the processing blocks 50 is produced in the form of a programmable logic component, such as an FPGA (Field Programmable Gate Array), or further in the form of a dedicated integrated circuit, such as an ASIC (Application Specific Integrated Circuit).

The invention has been described hereinabove in relation to an aircraft, but same can be applied to any type of aircraft, in particular having to touch down with a non-zero speed.

1. An electronic device for guiding the pilot in piloting an aircraft for performing the alignment maneuver of the longitudinal axis of the aircraft with the runway centerline when landing said aircraft in the presence of a crosswind, said device being suitable for determining at a first instant, an occurrence close to the alignment maneuver and to trigger, upon said determination of the near occurrence, a first display command controlling the appearance, on a display medium intended for the pilot and displaying the horizon graduated according to a heading scale, of at least one first symbol at a specified position on the display medium with respect to the graduation of the horizon line;
said device being suitable for updating the current position of the first symbol on the horizon depending on the updated value of the aircraft heading;
said device being suitable for determining, at a second instant strictly following said first instant, that the alignment maneuver should now begin and then for triggering a second display command controlling a movement of a second symbol on the display medium, from the position of the first symbol, the direction of said displacement with respect to the horizon being determined depending on the direction of the crosswind with respect to the runway, and the value of the displacement being determined depending on the difference between the current dynamic sideslip of the aircraft and a current dynamic sideslip setpoint value calculated for the aircraft, said current dynamic sideslip corresponding to the angle between the current air speed of the aircraft and the current heading of said aircraft.

2. The electronic guiding device according to claim 1, wherein:
the first symbol is an aircraft heading reminder symbol and the device is suitable for determining the position of the heading reminder symbol with respect to the runway centerline mark along the horizon depending on the angle between the aircraft heading and the runway centerline; or
the first symbol is a dynamic sideslip reminder symbol, and the device is suitable for determining the position of the dynamic sideslip reminder symbol with respect to the ground speed marker of the aircraft along said horizon depending on said dynamic sideslip, a zero dynamic sideslip giving rise to the same position, on the horizon, of said first symbol and of the ground speed.

3. The electronic guiding device according to claim 2, suitable for controlling the display on the display medium of the first symbol at a given distance with respect to said mark;
the guiding device being suitable for determining said distance depending on the multiplication of a scale factor strictly less than 1 and of an angle difference with respect to the heading scale of said horizon on the display medium, said angle difference being the angle between the aircraft heading and the runway centerline when the first symbol is an aircraft heading reminder symbol, being the dynamic sideslip angle, respectively, when the first symbol is a dynamic sideslip reminder symbol

4. The guiding device according to claim 1, suitable for triggering, at said second instant, an appearance modification command controlling an appearance modification of the first symbol displayed on said display medium.

5. A method of guiding the pilot in the piloting of an aircraft for performing the alignment maneuver of the longitudinal axis of the aircraft with the runway centerline during the landing of said aircraft in the presence of a crosswind, using an electronic guiding device implementing the following steps:
determining at a first instant an occurrence close to the alignment maneuver and initiating, upon the determination of the near occurrence, of a first display command for controlling the appearance on a display medium intended for the pilot and displaying the horizon graduated according to a heading scale, of at least one first symbol at a specified position on the display medium with respect to the horizon line;
updating the current position of the first symbol on the horizon according to the updated value of the aircraft heading;
determining, at a second instant strictly following said first instant, that the alignment maneuver should now begin and then triggering a second display command controlling a movement of a second symbol on the display medium, from the position of the first symbol, the direction of said displacement with respect to the horizon being determined depending on the direction of the crosswind with respect to the runway, and the value of the displacement being determined depending on the difference between the current dynamic sideslip of the aircraft and a current dynamic sideslip setpoint value calculated for the aircraft, said current dynamic sideslip corresponding to the angle between the current air speed of the aircraft and the current heading of said aircraft.

6. The guiding method according to claim 5, wherein:
the first symbol is an aircraft heading reminder symbol and the position of the heading reminder symbol is determined with respect to the runway centerline mark along said horizon depending on the angle between the aircraft heading and the runway centerline; or
the first symbol is a dynamic sideslip reminder symbol, and the device is suitable for determining the position of the dynamic sideslip reminder symbol with respect to the ground speed marker of the aircraft along said horizon depending on said dynamic sideslip, a zero dynamic sideslip giving rise to the same position, on the horizon, of said first symbol and of the ground speed.

7. The guiding method according to claim 5, comprising a step of controlling, by means of the guiding device, the display on the display medium of the first symbol at a given distance with respect to said mark; according to which method, said distance is determined by the guiding device depending on the multiplication of a scale factor strictly less than 1 and of an angle difference with respect to the heading scale of said horizon on the display medium, said angle difference being the angle between the aircraft heading and the runway centerline when the first symbol is an aircraft heading reminder symbol, being the dynamic sideslip angle, respectively, when the first symbol is a dynamic sideslip reminder symbol.

8. The guiding method according to claim 5, comprising a step of triggering, by means of the guiding device, at said second instant, an appearance modification command controlling an appearance modification of the first symbol displayed on said display medium.

9. The guiding method according to claim 5, the steps triggered at said second instant prompt the pilot to perform the alignment maneuver so that the first symbol stays as close as possible to the second symbol.

10. A non-transitory computer-readable medium on which is stored software instructions which, when executed by a computer, implement a method according to claim 5.

11. The guiding device according to claim 2, suitable for triggering, at said second instant, an appearance modification command controlling an appearance modification of the first symbol displayed on said display medium.

12. The guiding device according to claim 3, suitable for triggering, at said second instant, an appearance modification command controlling an appearance modification of the first symbol displayed on said display medium.

13. The guiding method according to claim 6, comprising a step of controlling, by means of the guiding device, the display on the display medium of the first symbol at a given distance with respect to said mark; according to which method, said distance is determined by the guiding device depending on the multiplication of a scale factor strictly less than 1 and of an angle difference with respect to the heading scale of said horizon on the display medium, said angle difference being the angle between the aircraft heading and the runway centerline when the first symbol is an aircraft heading reminder symbol, being the dynamic sideslip angle, respectively, when the first symbol is a dynamic sideslip reminder symbol.

14. The guiding method according to claim 6, comprising a step of triggering, by means of the guiding device, at said second instant, an appearance modification command controlling an appearance modification of the first symbol displayed on said display medium.

15. The guiding method according to claim 7, comprising a step of triggering, by means of the guiding device, at said second instant, an appearance modification command controlling an appearance modification of the first symbol displayed on said display medium.

16. The guiding method according to claim 6, the steps triggered at said second instant prompt the pilot to perform the alignment maneuver so that the first symbol stays as close as possible to the second symbol.

17. The guiding method according to claim 7, the steps triggered at said second instant prompt the pilot to perform the alignment maneuver so that the first symbol stays as close as possible to the second symbol.

18. The guiding method according to claim 8, the steps triggered at said second instant prompt the pilot to perform the alignment maneuver so that the first symbol stays as close as possible to the second symbol.

19. A non-transitory computer-readable medium on which is stored software instructions which, when executed by a computer, implement a method according to claim 6.

20. A non-transitory computer-readable medium on which is stored software instructions which, when executed by a computer, implement a method according to claim 7.
